(19) United States
(12) Patent Application Publication
(10) Pub. No.: US 2024/0177217 A1
(43) Pub. Date: May 30, 2024

(54) SYSTEM AND METHOD OF GENERATING DIGITAL ITEM RECOMMENDATIONS

(71) Applicant: Direct Cursus Technology L.L.C, Dubai (AE)

(72) Inventors: Mikhail ROYZNER, Moscow (RU); Daniil BURLAKOV, Moscow (RU)

(21) Appl. No.: 18/523,334

(22) Filed: Nov. 29, 2023

(30) Foreign Application Priority Data
Nov. 30, 2022 (RU) 2022131170

(51) Int. Cl. G06Q 30/0601; G06Q 30/0201; G06Q 30/0282

(52) U.S. Cl. CPC G06Q 30/0631; G06Q 30/0201; G06Q 30/0282

(57) ABSTRACT

A method and a server for generating digital item recommendations for a given user of an online recommendation platform are provided. The method comprises: generating a set of digital items to be recommended to the given user, the set of digital items including: a sub-set of core digital items, for a given core digital item of the sub-set of core digital items, the set of digital items further including: at least one auxiliary digital item to be provided to the given user in response to a respective user interaction of the given user with the given core digital item during appreciation thereof, the at least one auxiliary digital item having been determined based at least on an assumption that the given user has executed the respective user interaction with the given core digital item; and transmitting the set of digital items to an electronic device associated with the given user.

### CROSS-REFERENCE

The present application claims priority to Russian Patent Application No. 2022131170, entitled “System and Method of Generating Digital Item Recommendations”, filed Nov. 30, 2022, the entirety of which is incorporated herein by reference.

### FIELD

The present technology relates generally to recommendations systems; and in particular, to a method of generating digital item recommendations for users of online recommendation platforms.

### BACKGROUND

Online recommendation platforms host various digital items to be provided to the users thereof. Some of the online recommendation platforms comprise streaming platforms, for example, audio or video streaming platforms as a Sportify™ audio streaming platform, a Yandex.Music™ audio streaming platform, a Netflix™ video streaming platform, an Amazon™ Prime Video streaming platform, and the like, hosting various audio tracks and video clips. Other online recommendation platforms can be implemented as online listing platforms, such as a Yandex™ Market online listing platform, an Amazon™ online listing platform, an Ozon.ru™ online listing platform, and others. These platforms allow the users to purchase various goods and services online. The given online recommendation platform can be configured to host millions or even tens or hundreds of millions of digital items for presentation to the users.

To assist the user in navigating through such a number of digital items hosted by the given online recommendation platform and increase their user satisfaction from interacting therewith, the given online recommendation platform can be configured to provide the user with user recommendations. For example, a request for the user recommendations can be triggered by the user appreciating a given digital item on the given online recommendation platform, such as an audio track on an audio streaming platform. In response, the given online recommendation platform can be configured to provide a list of recommended digital item to be sequentially presented to the user after the given digital item. In another example, the given online recommendation platform can be configured to determine and further provide the list of recommended digital items to the user in response to the user starting up the given online recommendation platform on her/his electronic device or the request for recommendations expressly. The recommended digital items can be, for example, of a similar category or provided by a same item provider, such as a singer.

The given online recommendation platform is typically configured to determine the list recommended digital items based on past user interactions of users of the online recommendation platform with the plurality of digital items thereof. Such a list can include, for example, tens, hundreds, or thousands recommended digital items.

However, as the user appreciates the list of recommended digital items, current user interactions with at least some recommended digital items thereof may be indicative that the list of recommended digital items includes digital items that are of less interest to the user. For example, the user can leave negative feedback under a given recommended digital item from the list of recommended digital items, such as by pushing a “DISLIKE” button or write a negative review under the given recommended digital item. In another example, the user may leave positive feedback under the given recommended digital item, such as by pushing a “LIKE” button or sharing the given recommended digital item via their account on social networks.

In response, the given online recommendation platform, based on this feedback, can be configured to re-determine at least a following recommended digital item of the list of recommended digital item for further presentation to the user. As the so re-determined recommended digital item has been determined based on most recent user interactions, it is believed to better accommodate for the user's interests.

However, determining new recommended digital item online for immediate presentation thereof to the user in response to each their current interactions can be very computationally demanding and hence can cause a long latency time of a server, hosting the given online recommendation platform, to deliver these new recommended digital items to the user for their appreciation. As a result, a user-perceivable time delay before receiving a given new recommended digital item on the electronic device of the user can occur, which can affect user satisfaction of the user from interacting with the given online recommendation platform. Certain prior art approaches have been proposed to tackle the above-identified technical problem.

U.S. Pat. No. 10,929,457-B2 issued on Feb. 23, 2021, assigned to Rcrdclub Corp, and entitled “USER-SPECIFIC MEDIA PLAYLISTS” discloses a media recommendation system may score media items according to user recommendations, popularity, and/or recency. The scores may be weighted to produce an overall score for each media item. Media items may be added to a pool for a specific user, from which media items are selected for playback. The contents of the pool may be modified based upon user feedback and other data. The pool may be modified dynamically and/or in real time as media items are consumed or rated by the user.

U.S. Pat. No. 7,196,258-B2 issued on Mar. 27, 2007, assigned to Microsoft Technology Licensing LLC, and entitled “AUTO PLAYLIST GENERATION WITH MULTIPLE SEED SONGS” discloses systems and/or methods that generate playlist(s) for a library or collection of media items via selecting a plurality of seed items, at least one of which is an undesirable seed item. Some of the seed items are desirable indicating that a user prefers additional media items similar to the desirable seed items and others are undesirable indicating that the user prefers additional media items dissimilar to the undesirable seed items. Additionally, the seed items can be weighted to establish a relative importance of the seed items. The invention compares media items in the collection with the seed items and determines which media items are added into the playlist by computation of similarity metrics or values. The playlist can be regenerated by adding desirable seed items to the playlist and removing media items from the playlist (e.g., undesirable seed items).

### SUMMARY

Therefore, there is a need for systems and methods which avoid, reduce or overcome the limitations of the prior art.

Developers of the present technology have appreciated that providing the recommended digital items in smaller sets including, for example, 5 or 10 recommended digital items, can enable a more efficient determination of a new set of recommended digital items.

Further, the developers have also appreciated that pre-determining auxiliary recommended digital items to be presented to the user in response to potential user interactions of the user while appreciating a given recommended digital item from the set of recommended digital items in advance may allow even further increasing efficiency of the given online recommendation platform. More specifically, at least some non-limiting embodiments of the present technology are directed to pre-determining, for the given recommended digital item of the set of recommended digital items, a respective sub-set of auxiliary recommended digital items, each of which is presented to the user in response to their respective interaction with the given recommended digital item.

Returning to the example above, in response to the user providing either the negative or positive feedback to the given recommended digital item, instead of determining the new recommended digital items online, the given online recommendation platform can be configured to provide to the user the respective auxiliary recommended digital item that has been predetermined (or otherwise reserved) for these user interactions with the given recommended digital item. Further, during the user appreciating the respective auxiliary digital item, the given online recommendation platform can be configured to generate the new set of recommended digital items and provide it to the user without delays.

Thus, the presently described methods and systems allow decreasing an amount of computational resources of the online recommendation platforms utilized in real time, thereby reducing the latency time of the server, which can further translate to improved user experience from interacting with the online recommendation platforms.

More specifically, in accordance with a first broad aspect of the present technology, there is provided a computer-implementable method of generating digital item recommendations for a given user of an online recommendation platform. The online recommendation platform hosts a plurality of digital items. The method is executable by a server hosting the online recommendation platform. The method comprises: generating, by the server, a set of digital items to be recommended to the given user, the generating being based on past user interactions with the online recommendation platform, the set of digital items including: a sub-set of core digital items selected for the user based on the past user interactions, for a given core digital item of the sub-set of core digital items, the set of digital items further including: at least one auxiliary digital item to be provided to the given user in response to a respective user interaction of the given user with the given core digital item during appreciation thereof, the at least one auxiliary digital item having been determined based on (i) past user interactions of the given user with the plurality of digital items and (ii) an assumption that the given user has executed the respective user interaction with the given core digital item; and transmitting, by the server, the set of digital items to an electronic device associated with the given user.

In some implementations of the method, the method further comprises determining, by the server, the at least one auxiliary digital item.

In some implementations of the method, the determining the at least one auxiliary digital item comprises: in case of the respective user interaction is indicative of a positive user engagement with the given core digital item, determining, by the server, the at least one auxiliary digital item which is similar to the given core digital item; and in case of the respective user interaction is indicative of a negative user engagement with the given core digital item, determining, by the server, the at least one auxiliary digital item which is different from the given core digital item.

In some implementations of the method, each one of the plurality of digital items is associated with at least one item feature; and the determining the at least one auxiliary digital item which is one of similar to and different from the given core digital item comprises determining, by the server, in the plurality of digital items, a digital item having the at least one feature which is, respectively, one of similar to and different from a respective item feature of the given core digital item.

In some implementations of the method, the at least one item feature comprises one of: a category of the digital item and an item provider of the digital item.

In some implementations of the method, the online recommendation platform is an audio streaming platform; the digital item is an audio track; and the at least one item feature comprises one of: a genre of the audio track, a mood induced by the audio track, a rhythm of the audio track, an artist performing the audio track, an album including the audio track, and user-generated playlists including the audio track.

In some implementations of the method, the at least one auxiliary digital item comprises: a first auxiliary digital item, similar to the given core digital item, to be provided to the given user in case of the respective user interaction being indicative of the positive user engagement with the given core digital item; and a second auxiliary digital item, different from the given core digital item, to be provided to the given user in case of the respective user interaction being indicative of the negative user engagement with the given core digital item.

In some implementations of the method, the determining the at least one auxiliary digital item further comprises applying a machine-learning algorithm (MLA) having been trained to determine, in the plurality of digital items, recommended digital items for users of the online recommendation platform based on past user interactions of the users with the plurality of digital items.

In some implementations of the method, the method further comprises: causing, by the server, presentation of the set of digital items on the electronic device associated with the given user; such that in response to receiving an indication of the respective user interaction with the given core digital item during the appreciation thereof, the electronic device is configured to: abort presentation of the given core digital item; execute presentation of the at least one auxiliary digital item; and transmit a request to the server for generating, by the server, based on the at least on the auxiliary digital item, an other set of digital items to be recommended to the given user after appreciation of the auxiliary digital item such that: each one of a respective sub-set of core digital items of the other set of digital items is similar to the at least one auxiliary digital item; and in response to an absence of any user interaction with the given core digital item, the electronic device is configured to: execute, after the presentation of the given core digital item, presentation of a sequentially following core digital item in the sub-set of core digital items.

In some implementations of the method, the presentation of the set of digital items on the electronic device associated with the given user is further configured to trigger the electronic device to: in response to an absence of any user interaction with any one of the sub-set of core digital items until a predetermined percentage of presentation of a last one thereof, transmit a request to the server for generating, by the server, the other set of digital items to be recommended to the given user after appreciation of the set of digital items such that: each one of the respective sub-set of core digital items of the other set of digital items is similar to at least one of the sub-set of core digital items of the set of digital items.

In some implementations of the method, the respective user interaction comprises the given user providing user feedback about the at least one auxiliary digital item.

In some implementations of the method, the sub-set of core digital items has a predetermined number of digital items.

In some implementations of the method, the predetermined number has been determined such that a latency of the server is minimized.

In some implementations of the method, the online recommendation platform is an audio streaming platform; and a given one of the plurality of digital items is a respective audio track.

In accordance with a second broad aspect of the present technology, there is provided a server for generating digital item recommendations for a given user of an online recommendation platform hosted by the server. The online recommendation platform hosts a plurality of digital items. The server comprising a processor and a non-transitory computer-readable memory storing instructions. The processor, upon executing the instructions, is configured to: generate a set of digital items to be recommended to the given user, the generating being based on past user interactions with the online recommendation platform, the set of digital items including: a sub-set of core digital items selected for the user based on the past user interactions, for a given core digital item of the sub-set of core digital items, the set of digital items further including: at least one auxiliary digital item to be provided to the given user in response to a respective user interaction of the given user with the given core digital item during appreciation thereof, the at least one auxiliary digital item having been determined based on (i) past user interactions of the given user with the plurality of digital items and (ii) an assumption that the given user has executed the respective user interaction with the given core digital item; and transmit the set of digital items to an electronic device associated with the given user.

In some implementations of the server, the processor is further configured to determine the at least one auxiliary digital item.

In some implementations of the server, the processor is configured to determine the at least one auxiliary digital item, by: in case of the respective user interaction is indicative of a positive user engagement with the given core digital item, determining the at least one auxiliary digital item which is similar to the given core digital item; and in case of the respective user interaction is indicative of a negative user engagement with the given core digital item, determining the at least one auxiliary digital item which is different from the given core digital item.

In some implementations of the server, each one of the plurality of digital items is associated with at least one item feature; and the processor is configured to determine the at least one auxiliary digital item which is one of similar to and different from the given core digital item by determining, in the plurality of digital items, a digital item having the at least one feature which is, respectively, one of similar to and different from a respective item feature of the given core digital item.

In some implementations of the server, to determine the at least one auxiliary digital item the processor is further configured to apply a machine-learning algorithm (MLA) having been trained to determine, in the plurality of digital items, recommended digital items for users of the online recommendation platform based on past user interactions of the users with the plurality of digital items.

In some implementations of the server, the processor is further configured to: cause presentation of the set of digital items on the electronic device associated with the given user; such that in response to receiving an indication of the respective user interaction with the given core digital item during the appreciation thereof, the electronic device is configured to: abort presentation of the given core digital item; execute presentation of the at least one auxiliary digital item; and transmit a request to the server for generating, by the server, based on the at least on the auxiliary digital item, an other set of digital items to be recommended to the given user after appreciation of the auxiliary digital item such that: each one of a respective sub-set of core digital items of the other set of digital items is similar to the at least one auxiliary digital item; and in response to an absence of any user interaction with the given core digital item, the electronic device is configured to: execute, after the presentation of the given core digital item, presentation of a sequentially following core digital item in the sub-set of core digital items.

In the context of the present specification, a “server” is a computer program that is running on appropriate hardware and is capable of receiving requests (e.g. from electronic devices) over a network, and carrying out those requests, or causing those requests to be carried out. The hardware may be implemented as one physical computer or one physical computer system, but neither is required to be the case with respect to the present technology. In the present context, the use of the expression a “server” is not intended to mean that every task (e.g. received instructions or requests) or any particular task will have been received, carried out, or caused to be carried out, by the same server (i.e. the same software and/or hardware); it is intended to mean that any number of software elements or hardware devices may be involved in receiving/sending, carrying out or causing to be carried out any task or request, or the consequences of any task or request; and all of this software and hardware may be one server or multiple servers, both of which are included within the expression “at least one server”.

In the context of the present specification, “electronic device” is any computer hardware that is capable of running software appropriate to the relevant task at hand. In the context of the present specification, the term “electronic device” implies that a device can function as a server for other electronic devices, however it is not required to be the case with respect to the present technology. Thus, some (non-limiting) examples of electronic devices include self-driving unit, personal computers (desktops, laptops, netbooks, etc.), smartphones, and tablets, as well as network equipment such as routers, switches, and gateways. It should be understood that in the present context the fact that the device functions as an electronic device does not mean that it cannot function as a server for other electronic devices.

In the context of the present specification, the expression “information” includes information of any nature or kind whatsoever capable of being stored in a database. Thus information includes, but is not limited to visual works (e.g. maps), audiovisual works (e.g. images, movies, sound records, presentations etc.), data (e.g. location data, weather data, traffic data, numerical data, etc.), text (e.g. opinions, comments, questions, messages, etc.), documents, spreadsheets, etc.

In the context of the present specification, a “database” is any structured collection of data, irrespective of its particular structure, the database management software, or the computer hardware on which the data is stored, implemented or otherwise rendered available for use. A database may reside on the same hardware as the process that stores or makes use of the information stored in the database or it may reside on separate hardware, such as a dedicated server or plurality of servers.

In the context of the present specification, the words “first”, “second”, “third”, etc. have been used as adjectives only for the purpose of allowing for distinction between the nouns that they modify from one another, and not for the purpose of describing any particular relationship between those nouns. Further, as is discussed herein in other contexts, reference to a “first” element and a “second” element does not preclude the two elements from being the same actual real-world element.

Implementations of the present technology each have at least one of the above-mentioned object and/or aspects, but do not necessarily have all of them. It should be understood that some aspects of the present technology that have resulted from attempting to attain the above-mentioned object may not satisfy this object and/or may satisfy other objects not specifically recited herein.

Additional and/or alternative features, aspects and advantages of implementations of the present technology will become apparent from the following description, the accompanying drawings and the appended claims.

### BRIEF DESCRIPTION OF THE DRAWINGS

These and other features, aspects and advantages of the present technology will become better understood with regard to the following description, appended claims, and accompanying drawings where:

FIG. 1 depicts a schematic diagram of an example computer system configurable for implementing certain non-limiting embodiments of the present technology;

FIG. 2 depicts a schematic diagram of a networked computing environment including the computer system of FIG. 1 and being suitable for use with certain non-limiting embodiments of the present technology;

FIG. 3 depicts a schematic diagram of a Graphical User Interface of an online recommendation platform hosted by a server present in the networked computing environment of FIG. 2, in accordance with certain non-limiting embodiments of the present technology;

FIG. 4 depicts a schematic diagram of a machine-learning model architecture used for implementation at least some non-limiting embodiments of the present technology;

FIG. 5 depicts a schematic diagram of a first configuration of a set of recommended digital items determined by the server present in the networked computing environment of FIG. 2 for presentation to a user of the online recommendation platform, in accordance with certain non-limiting embodiments of the present technology;

FIG. 6 depicts a schematic diagram of a second configuration of the set of recommended digital items determined by the server present in the networked computing environment of FIG. 2 for presentation to the user of the online recommendation platform, in accordance with certain non-limiting embodiments of the present technology; and

FIG. 7 depicts a flowchart diagram of a method of generating, by the server present in the networked computing environment in FIG. 2, the set of recommended digital items, item recommendations, in accordance with certain non-limiting embodiments of the present technology.

### DETAILED DESCRIPTION

The examples and conditional language recited herein are principally intended to aid the reader in understanding the principles of the present technology and not to limit its scope to such specifically recited examples and conditions. It will be appreciated that those skilled in the art may devise various arrangements which, although not explicitly described or shown herein, nonetheless embody the principles of the present technology and are included within its spirit and scope.

Furthermore, as an aid to understanding, the following description may describe relatively simplified implementations of the present technology. As persons skilled in the art would understand, various implementations of the present technology may be of a greater complexity.

In some cases, what are believed to be helpful examples of modifications to the present technology may also be set forth. This is done merely as an aid to understanding, and, again, not to define the scope or set forth the bounds of the present technology. These modifications are not an exhaustive list, and a person skilled in the art may make other modifications while nonetheless remaining within the scope of the present technology. Further, where no examples of modifications have been set forth, it should not be interpreted that no modifications are possible and/or that what is described is the sole manner of implementing that element of the present technology.

Moreover, all statements herein reciting principles, aspects, and implementations of the technology, as well as specific examples thereof, are intended to encompass both structural and functional equivalents thereof, whether they are currently known or developed in the future. Thus, for example, it will be appreciated by those skilled in the art that any block diagrams herein represent conceptual views of illustrative circuitry embodying the principles of the present technology. Similarly, it will be appreciated that any flowcharts, flow diagrams, state transition diagrams, pseudo-code, and the like represent various processes which may be substantially represented in computer-readable media and so executed by a computer or processor, whether or not such computer or processor is explicitly shown.

The functions of the various elements shown in the figures, including any functional block labeled as a “processor”, may be provided through the use of dedicated hardware as well as hardware capable of executing software in association with appropriate software. When provided by a processor, the functions may be provided by a single dedicated processor, by a single shared processor, or by a plurality of individual processors, some of which may be shared. Moreover, explicit use of the term “processor” or “controller” should not be construed to refer exclusively to hardware capable of executing software, and may implicitly include, without limitation, digital signal processor (DSP) hardware, network processor, application specific integrated circuit (ASIC), field programmable gate array (FPGA), read-only memory (ROM) for storing software, random-access memory (RAM), and non-volatile storage. Other hardware, conventional and/or custom, may also be included.

Software modules, or simply modules which are implied to be software, may be represented herein as any combination of flowchart elements or other elements indicating performance of process steps and/or textual description. Such modules may be executed by hardware that is expressly or implicitly shown.

With these fundamentals in place, we will now consider some non-limiting examples to illustrate various implementations of aspects of the present technology.

### Computer System

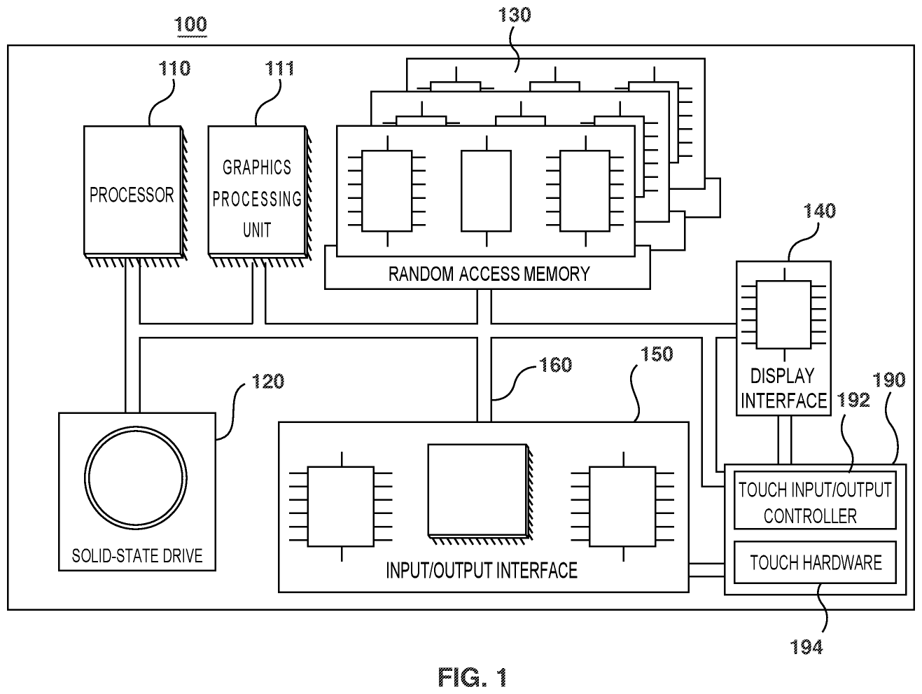

With reference to FIG. 1, there is depicted a computer system 100 suitable for use with some implementations of the present technology. The computer system 100 comprises various hardware components including one or more single- or multi-core processors collectively represented by a processor 110, a graphics processing unit (GPU) 111, a solid-state drive 120, a random-access memory 130, a display interface 140, and an input/output interface 150.

Communication between the various components of the computer system 100 may be enabled by one or more internal and/or external buses 160 (e.g., a PCI bus, universal serial bus, IEEE 1394 “Firewire” bus, SCSI bus, Serial-ATA bus, etc.), to which the various hardware components are electronically coupled.

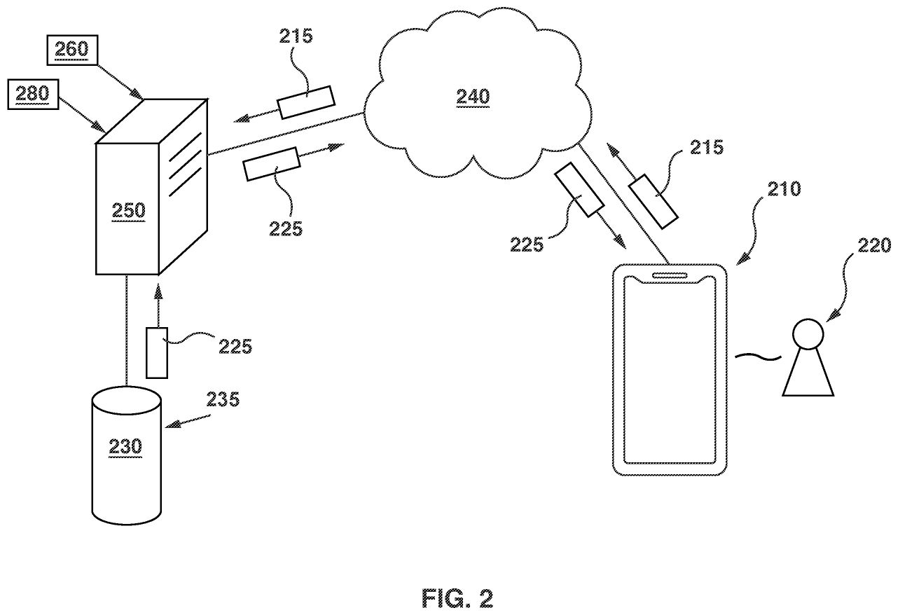

The input/output interface 150 may be coupled to a touchscreen 190 and/or to the one or more internal and/or external buses 160. The touchscreen 190 may equally be referred to as a screen—such as a screen (not separately labelled) of an electronic device 210 depicted in FIG. 2. In the embodiments illustrated in FIG. 1, the touchscreen 190 comprises touch hardware 194 (e.g., pressure-sensitive cells embedded in a layer of a display allowing detection of a physical interaction between a user and the display) and a touch input/output controller 192 allowing communication with the display interface 140 and/or the one or more internal and/or external buses 160. In some non-limiting embodiments of the present technology, the input/output interface 150 may be connected to a keyboard (not separately depicted), a mouse (not separately depicted) or a trackpad (not separately depicted) allowing the user to interact with the computer system 100 in addition to or instead of the touchscreen 190.

It is noted some components of the computer system 100 can be omitted in some non-limiting embodiments of the present technology. For example, the keyboard and the mouse (both not separately depicted) can be omitted, especially (but not limited to) where the computer system 100 is implemented as a compact electronic device, such as a smartphone.

According to implementations of the present technology, the solid-state drive 120 stores program instructions suitable for being loaded into the random-access memory 130 and executed by the processor 110 and/or the GPU 111. For example, the program instructions may be part of a library or an application.

### Networked Computing Environment

With reference to FIG. 2, there is depicted a networked computing environment 200 suitable for use with some non-limiting embodiments of the present technology. The networked computing environment 200 includes an electronic device 210 communicatively coupled, via a communication network 240, with a server 250. In the non-limiting embodiments of the present technology, the electronic device 210 may be associated with a user 220.

In the non-limiting embodiments of the present technology, the electronic device 210 may be any computer hardware that is capable of running a software appropriate to the relevant task at hand. Thus, some non-limiting examples of the electronic device 210 may include personal computers (desktops, laptops, netbooks, etc.), smartphones, and tablets. Thus, the electronic device 210 may comprise some or all components of the computer system 100 depicted in FIG. 1.

According to certain non-limiting embodiments of the present technology, the server 250 can be configured to host an online recommendation platform 260; and the processor 110 of the electronic device 210 can be configured to access the online recommendation platform 260 via the communication network 240. Broadly speaking, the online recommendation platform 260 is a web resource providing the user 220 with access to a plurality of digital items 235 stored in a database 230 communicatively coupled to the server 250 via a respective communication link. More specifically, the online recommendation platform 260 can be configured to identify digital items that may interest the user 220 and further transmit the indications of such digital items to the electronic device 210 for user's appreciation.

It is not limited how the online recommendation platform 260 can be implemented. In some non-limiting embodiments of the present technology, the online recommendation platform 260 can be implemented as an audio streaming platform, such as a Sportify™ audio streaming platform, a Yandex.Music™ audio streaming platform, a YouTube.Music™ audio streaming platform, and others; and the plurality of digital items 235 stored in the database 230 can comprise various audio tracks, such as songs, podcasts, audio books, and the like. In other non-limiting embodiments of the present technology, the online recommendation platform can be implemented as video streaming platform, such as a Netflix™ video streaming platform, an Amazon™ Prime Video streaming platform, and others; and the plurality of digital items 235 can comprise video clips, films, and TV programs, as an example. In yet other non-limiting embodiments of the present technology, the online recommendation platform 260 can be implemented as an online listing platform, such as a Yandex.Market™ online listing platform, and Amazon™ online listing platform; and the plurality of digital items 235 can comprise classified listings of various goods and services available for online purchasing. Other implementations of the online recommendation platform 260 are also envisioned without departing from the scope of the present technology.

In some non-limiting embodiments of the present technology, the server 250 can be implemented as a conventional computer server and may comprise some or all of the components of the computer system 100 of FIG. 1. In one non-limiting example, the server 250 is implemented as a Dell™ PowerEdge™ Server running the Microsoft™ Windows Server™ operating system, but can also be implemented in any other suitable hardware, software, and/or firmware, or a combination thereof. In the depicted non-limiting embodiments of the present technology, the server 250 is a single server. In alternative non-limiting embodiments of the present technology (not depicted), the functionality of the server 250 may be distributed and may be implemented via multiple servers.

In some non-limiting embodiments of the present technology, the server 250 can be operated by the same entity that has provided the online recommendation platform 260. For example, if the online recommendation platform 260 is the Yandex.Music™ audio streaming platform, the server 250 can also be operated by Yandex LLC of 16 Lev Tolstoy Street, Moscow, 119021, Russia. In alternative non-limiting embodiments of the present technology, the server 250 can be operated by an entity different from the one that has provided the online recommendation platform 260.

For example, using the electronic device 210, the user 220 can be enabled to access the online recommendation platform 260 from the electronic device 210. Further, the user 220 can be enabled to submit a recommendation request 215 to server 250. In response, the server 250 can be configured to (i) identify a set of recommended digital items 225 and (ii) transmit indications of the set of recommended digital items 225 to the electronic device for presentation to the user 220. It is not limited how the recommendation request 215 can be submitted by the user 220.

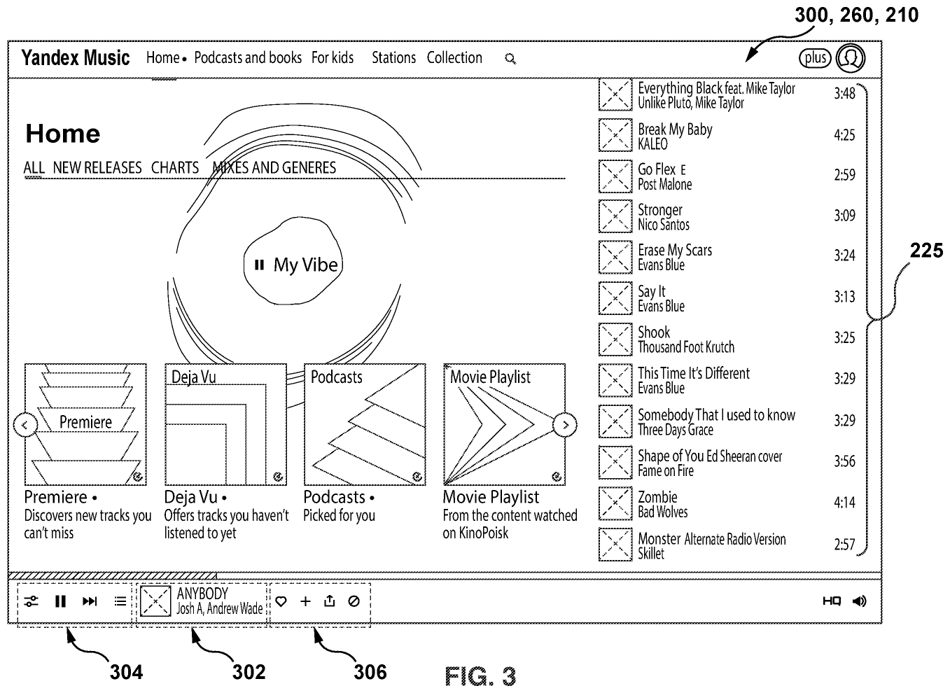

How the recommendation request 215 can be submitted to the server 250; and how, in response, the server 250 can further be configured to determine the set of recommended digital items 225, in accordance with certain non-limiting embodiments of the present technology, will be described below withe reference to FIGS. 3 to 5.

### Communication Network

In some non-limiting embodiments of the present technology, the communication network 240 is the Internet. In alternative non-limiting embodiments of the present technology, the communication network 240 can be implemented as any suitable local area network (LAN), wide area network (WAN), a private communication network or the like. It should be expressly understood that implementations for the communication network are for illustration purposes only. How a respective communication link (not separately numbered) between each one of the electronic device 210, the server 250, and the communication network 240 is implemented will depend, inter alia, on how each one of the electronic device 210 and the server 250 is implemented. Merely as an example and not as a limitation, in those embodiments of the present technology where the electronic device 210 is implemented as a wireless communication device such as the smartphone, the communication link can be implemented as a wireless communication link. Examples of wireless communication links include, but are not limited to, a 3G communication network link, a 4G communication network link, and the like. The communication network 240 may also use a wireless connection with the server 250.

### Recommendation Platform

With reference to FIG. 3, there is depicted a graphical user interface (GUI) 300 of the online recommendation platform 260 rendered in the electronic device 210 associated with the user 220, in accordance with certain non-limiting embodiments of the present technology.

According to certain non-limiting embodiments of the present technology, the server 250 can be configured to cause the electronic device 210 to render the GUI 300 in response to the user 220 submitting a request for accessing the online recommendation platform 260, such as by submitting a Universal Resource Locator (URL) of the server 250 to a browser application (not separately depicted) of the electronic device 210 or launching thereon an application (not separately numbered in FIG. 3) associated with the online recommendation platform 260.

As it can be appreciated, in some non-limiting embodiments of the present technology, the GUI 300 can include at least: (i) respective indications of at least a portion of the set of recommended digital items 225, defined by dimensions of a screen of the electronic device 210; (ii) an indication of a currently presented recommended digital item 302; control actuators 304 enabling the user 220 to control the presentation of a given recommended digital item; and (iii) feedback actuators 306 enabling the user 220 to leave their feedback on the given recommended digital item of the set of recommended digital items 225, such as the currently presented recommended digital item 302.

Although in the embodiments depicted in FIG. 3, the GUI 300 is representative of the online recommendation platform 260 implemented as an audio streaming platform, it should be expressly understood that, in other non-limiting embodiments of the present technology, similar GUIs can be rendered for other types of the online recommendation platform 260, non-exhaustively listed above.

Further, it is not limited how the recommendation request 215 for the set of recommended digital items 225 can be submitted from electronic device 210. In some non-limiting embodiments of the present technology, the user 220 can be enabled, such as via a dedicated actuator (such as “Play Radio”, in the example where the online recommendation platform 260 is an audio streaming platform, not depicted in FIG. 3) of the GUI 300, to expressly submit the recommendation request 215 to the server 250. In other non-limiting embodiments of the present technology, the recommendation request 215 can be triggered by the user 220 accessing the online recommendation platform 260 from the electronic device 210, launching the GUI 300. In yet other non-limiting embodiments of the present technology, the recommendation request 215 can be triggered by the user 220 appreciating the given digital item of the plurality of digital items 235.

In some non-limiting embodiments of the present technology, the server 250 can be configured to generate the set of recommended digital items 225 for the user 220 based on past user interactions of users of the online recommendation platform 260 with the plurality of digital items 235. According to certain non-limiting embodiments of the present technology, such user interactions of the users of the online recommendation platform 260, such as those of the user 220, may be indicative of one of a positive user engagement or a negative user engagement with the given digital item of the plurality of digital items 235. Broadly speaking, the positive user engagement of the user 220 with the given digital item is indicative of that the user 220 has found the given digital item of interest, or in other words, has been satisfied with the given digital item presented thereto. Thus, by way of example, and not as a limitation, the user interactions of the user 220 indicative of the positive user engagement with the given digital item can include: (i) selecting the given digital item for appreciation; (ii) searching for the given digital item on the online recommendation platform 260; (iii) sharing the given digital item via accounts of the user 220 on social networks; (iv) putting presentation of the given digital item on repeat; (v) adding the given digital item to a list of favorite digital items of the user 220; and (vi) providing positive user feedback under the given digital item.

By contrast, the negative user engagement of the user 220 with the given digital item can denote that the user 220 has found the given digital item dissatisfying. Thus, the user interactions of the user 220 indicative of the negative user engagement with the given digital item of the plurality of digital items can include, for example, without limitation: (i) skipping forward the given digital item; (ii) skipping the given digital item in its entirety to a sequentially following digital item; (iii) aborting the presentation of the given digital item followed by searching an other digital item for appreciation; (iv) providing negative user feedback to the given digital item; and the like. Other user interactions of the user 220, indicative of both the positive and negative user engagement with the given digital item, are also envisioned without departing from the scope of the present technology.

Further, it is not limited how the online recommendation platform 260 can be configured to enable the user feedback for each one of the plurality of digital items 235. In some non-limiting embodiments of the present technology, as mentioned above, the GUI 300 can include the feedback actuators 306 enabling the user feedback to be indicated by a binary value, such as “LIKE” or “DISLIKE”, respectively indicative of the positive or negative user engagement of the user 220 with the given digital item. In other non-limiting embodiments of the present technology, the feedback actuators 306 can include a different configuration (such as star indicators, emotion indicators, and the like, not depicted) enabling indication of the user feedback by one of values of a predetermined value range, such as from “1” to “5” or from “1” to “10”, for example, where “1” is indicative of the negative user engagement of the user 220 with the given digital item, and “5” or “10”, respectively, are indicative the positive user engagement of the user 220 with the given digital item.

In alternative non-limiting embodiments of the present technology, the GUI 300 of the online recommendation platform 260 can include additional interface elements enabling the user 220 to indicate the user feedback in a form of a user comment and/or review on the given digital item. Further, in these embodiments, the server 250 can be configured to determine whether the user comments and/or reviews are indicative of the positive or negative user engagement of the user 220 with the given digital item. To that end, for example, the server 250 can be configured to execute a Natural Language Processing (NLP) model configured to process and understand natural human language. It is not limited how the NLP model can be implemented, and in various non-limiting embodiments of the present technology, the NLP model can be implemented based on artificial neural networks (NN), such as a Transformed-based NN, a Long Short-Term Memory NN, a Recurrent NN, and the like. In these embodiments, the NLP model is preliminarily trained based on large corpora of texts including natural human language. In specific non-limiting embodiments, the NLP model can be implemented and trained as described in a co-owned Russian Patent Application No.: 2021138538, filed with the Russian Federal Institute of Industrial Property on Dec. 23, 2021, and entitled “METHOD AND SYSTEM FOR RECOGNIZING A USER UTTERANCE”, the content of which is incorporated herein by reference in its entirety.

Also, it is not limited how the server 250 can be configured to identify the set of recommended digital items 225 for the user 220 based on the past user interactions of users of the online recommendation platform 260 with the plurality of digital items 235. In some non-limiting embodiments of the present technology, the server 250 can be configured to identify the set of recommended digital items 225 such that a likelihood value of the positive user engagement of the user 220 with each one of the set of recommended digital items 225 is maximized. In other non-limiting embodiments of the present technology, the server 250 can be configured to identify the set of recommended digital items 225 such that a likelihood value of the negative user engagement of the user 220 with each one of the set of recommended digital items 225 is minimized.

To that end, for example, in some non-limiting embodiments of the present technology, the server 250 can be configured to identify recommended digital items for the set of recommended digital items 225 that have similar item features with those digital items, with which the user 220 has had most positive user engagement, as mentioned above. In another example, the server 250 can be configured to identify the recommended digital items for inclusion thereof in the set of recommended digital items 225 among those having received positive user engagements of other users of the online recommendation platform 260 that have similar user features with the user 220.

According to certain non-limiting embodiments of the present technology, the item features associated with the given digital item may be indicative of inherent parameters thereof; and, as it can be appreciated, can depend on a nature of the given current digital item. For example, in those embodiments where the online recommendation platform 260 is an online streaming platform, and the given digital item is a respective audio track, the item features can include, without limitation, (i) a genre of the respective audio track; (ii) a predetermined mood to be induced by the respective audio track; (iii) a period of popularity associated with the respective audio track, such as the sixties, the seventies, the nineties, and the like; (iv) a respective item provider of the respective audio track, such as an artist, a producer, a production studio, and the like; (v) a duration of the respective audio track; (vi) a release date of the respective audio track; (vii) a rhythm of the respective audio track; (viii) an album of the respective audio track; and the like.

Further, the user features of a given user of the online recommendation platform 260, such as the user 220, can include, without limitation: (i) sociodemographic characteristics of the user 220, which may further include, without limitation, an age of the user 220, a gender of the user 220, an employment status of the user 220, an average income of the user 220, and the like; (ii) data indicative of a search history of the user 220; (iii) data indicative of a web browsing history of the user 220; and the like.

In some non-limiting embodiments of the present technology, to identify the set of recommended digital items 225 for the user 220 as mentioned above, the server 250 can be configured to execute a machine-learning algorithm (MLA) 280 trained to identify recommended digital items based on the above features for each user of the online recommendation platform 260. More specifically, executing the MLA 280 can be trained to determine respective likelihood values of the user 220 positively engaging with each one of the plurality of digital items 235, such as the user 220 leaving positive feedback thereon. Further, the server 250 can be configured to (i) rank the digital items according to respective likelihood values; and (ii) select N top digital items, such as 100, 500, or 1000, for example, as for inclusion in the set of recommended digital items 225.

In the non-limiting embodiments of the present technology, the MLA 280 may be based on neural networks (NN), convolutional neural networks (CNN), decision tree models, gradient boosted decision tree-based MLA, association rule learning based MLA, Deep Learning based MLA, inductive logic programming based MLA, support vector machines based MLA, clustering based MLA, Bayesian networks, reinforcement learning based MLA, representation learning based MLA, similarity and metric learning based MLA, sparse dictionary learning based MLA, genetic algorithms based MLA, and the like. For training the MLA 280, the server 250 may have employed a supervised-learning approach without departing from the scope of the present technology.

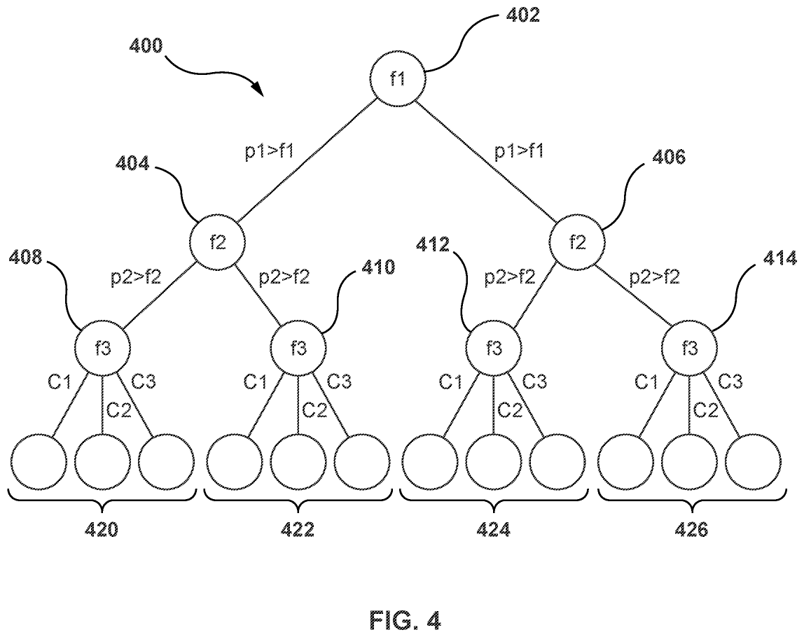

An example machine-learning model, based on which the MLA 280 can be implemented, in at least some non-limiting embodiments of the present technology, will be described immediately below with reference to FIG. 4.

### Machine-Learning Model Architecture

With reference to FIG. 4, there is depicted a schematic diagram of a decision tree model 400 that can be used with at least some non-limiting embodiments of the present technology. The decision tree model 400 aims at illustrating a generic decision tree model which may be modified so as to meet the requirements of a specific prediction model, such as the MLA 280. Such modifications may include, for example, but without being limited, adding or removing one or more level of the tree, adding or removing nodes (i.e., features and the associated splits), adding or removing branches connecting the nodes and/or the leaves of the tree.

The decision tree model 400 may be a trained tree model. In some non-limiting embodiments of the present technology, the decision tree model 400 may, once generated, be updated and/or modified to improve, for example, a level of accuracy of the machine-learning model and/or a scope of application of the machine-learning model. In some embodiments, the decision tree model 400 may be relied upon to determine, for example, but without being limited to, the respective likelihood values of users of the online recommendation platform 260, such as the user 220, positively engaging with each one of the plurality of digital items 235 hosted by the online recommendation platform 260. Other fields in which the decision tree model 400 may be relied upon may also be envisioned without departing from the scope of the present technology.

The decision tree model 400 comprises a first node 402 associated with a first feature “f1”. The first node 402 defines a first level of the decision tree model 400. The first node 402 is connected through branches to a second node 404 and a third node 406. The second node 404 and the third node 406 are both associated with a second feature “f2”. The second node 404 and the third node 406 define a second level of the decision tree model 400. In some non-limiting embodiments of the present technology, the first feature “f1” and the split for the first feature “f1” have been selected amongst a set of features to be positioned at a first level of the model tree 400 on the basis of a plurality of training digital objects. For example, a given feature may characterize at least one of: a given digital item, a given user having interacted therewith, and a how the give user interacted with the given item, as will be described in a greater detail below.

The first feature “f1” is defined so that, for a given digital object, a value of a parameter associated with the first feature “f1” determines whether the digital object is to be associated with the second node 404 or the third node 406. As an example, if the value is less than a value “f1” then the digital object is associated with the second node 404. As another example, if the value is more than the value “f1” then the digital object is associated with the third node 406.

In turn, the second node 404 is associated with a fourth node 408 associated with a third feature “B” and a fifth node 410 associated with the third feature “B”. The third node 406 is associated with a sixth node 412 associated with the third feature “B” and a seventh node 414 associated with the third feature “B”. The fourth node 408, the fifth node 410, the sixth node 412 and the seventh node 414 define a third level of the decision tree model 400. As previously described in connection with the first node 402, for a given digital object, a value of a parameter associated with the second feature “f2” determines whether the digital object is to be associated with the fourth node 408 or the fifth node 410 (if the digital object is associated with the second node 404) or the sixth node 412 or the seventh node 414 (if the digital object is associated with the third node 406).

In turn, each one of the fourth node 408, the fifth node 410, the sixth node 412 and the seventh node 414 are associated with sets of predicted parameters. In the example illustrated in FIG. 4, the sets of predicted parameters comprise a first set 420, a second set 422, a third set 424 and a fourth set 426. Each one of the sets of predicted parameters comprises three targets, namely “C1”, “C2” and “C3”, provided, for example, by human assessors, as will become apparent from the description provided below.

As a person skilled in the art of the present technology may appreciate, the decision tree model 400 illustrates an embodiment wherein a particular level of the decision tree model 400 is associated with one feature. In the example of FIG. 4, a first level comprises the first node 402 and is associated with the first feature “f1”; a second level comprises the second node 404 and the third node 406 and is associated with the second feature “f2”; and a third level comprises the fourth node 408, the fifth node 410, the sixth node 412 and the seventh node 414 and is associated with the third feature “B”.

In other words, in the embodiment of FIG. 4, the first level is associated with the first feature “f1”, the second level is associated with the second feature “f2” and the third level is associated with the third feature “f3”. Other embodiments may however be envisioned. In particular, an alternative embodiment wherein a generated tree model may include distinct features for a given level of the tree model. For example, a first level of such tree model may comprise a first node associated with a first feature “f1”, a second level may comprise a second node associated with a second feature “f2” and a third node associated with a third feature “f3”. As a person skilled in the art of the present technology may appreciate, other variations as to which features may be associated with a given level may be envisioned without departing from the scope of the present technology.

Further, how the features, such as the first feature “f1”, the second feature “f2”, and the third feature “f3”, have been selected for generating the decision tree model 400 is not limited. In some non-limiting embodiments of the present technology, selecting the features and thus associated splits between nodes of the decision tree model 400 can include optimizing a respective metric indicative of quality of a given feature to separate, along branches of the decision tree model 400, the plurality of training digital objects, during a training process, as each one of the plurality of training digital objects is fed to the decision tree model 400. In some non-limiting embodiments of the present technology, such a metric can include, without limitation, an Estimate of Positive Correctness metric, a Gini Impurity metric, an Information Gain metric, and the like. In specific non-limiting embodiments of the present technology, the features can be selected based on maximizing a prediction quality parameter of proto-trees making up the decision tree model 400, as described, for example, in a United States Patent Application Publication No.: 2019/164,084-A1, published on May 30, 2019, and entitled “METHOD OF AND SYSTEM FOR GENERATING PREDICTION QUALITY PARAMETER FOR A PREDICTION MODEL EXECUTED IN A MACHINE LEARNING ALGORITHM”, content of which is incorporated herein by reference in its entirety.

Further, according to certain non-limiting embodiments of the present technology, the MLA 280 may comprise a single instance of the decision tree model 400, in which case the MLA can be referred to as a single decision tree. However, in other non-limiting embodiments of the present technology, the MLA 280 can include an ensemble of decision trees implemented similarly to the decision tree model 400, in which case the MLA 280 can be referred to as a forest of decision trees. In this case, a final prediction of the ensemble of decision trees is based on prediction outcomes of each decision tree of the ensemble. How the ensemble of decision trees can be built is not limited, and may include, for example, using a boosting approach, such as a gradient boosting approach.

Generally speaking, the boosting is a method of building the ensemble of decision trees, where the trees are built in a stage-wise manner (as opposed to generating a random forest, as an example, where trees can be generated in parallel) such that a difference between targets and prediction outputs of the ensemble of decision trees is minimized, at each iteration, with generating each new decision tree thereof. The difference between the targets and the prediction outcomes of the ensemble of decision trees can be expressed, for example, by a loss function, such as a Cross-Entropy Loss Function.

It should be expressly understood that other implementations of the loss function are also envisioned by the non-limiting embodiments of the present technology and may include, by way of example, and not as a limitation, a Mean Squared Error Loss function, a Huber Loss function, a Hinge Loss function, and others.

In other words, by applying the boosting approach, the MLA 280 uses decision trees as week learners, which the MLA 280 sequentially combines in a way that each new learner fits to residuals from a previous iteration, thereby improving an aggregate outcome of the whole ensemble of decision trees. Put another way, each decision tree is built on the same plurality of training digital objects, however training digital objects, in which the first decision tree made “mistakes” in predicting are prioritized when building the decision second tree, etc. Further, the MLA 280 aggregates results from each iteration forming a strong learner.

In specific non-limiting embodiments of the present technology, the MLA 280 can comprise a CatBoost ensemble of decision trees, as described, for example, in an article “CatBoost: gradient boosting with categorical features support” by Dorogush et al., and published by YANDEX INC., content of which is incorporated herein by reference in its entirety.

Thus, generally speaking, the processor of the server 250 can be said to be executing two respective processes in respect of the MLA 280. A first process of the two processes is a training process, where the processor 110, for example, of the server 250 is configured to train the MLA 280, based on the plurality of training digital objects (also referred to herein as a “training set of data”), to determine the respective likelihood values of the user 220 positively engaging with each one of the plurality of digital items 235.

A second process is an in-use process, where the processor of the server 250 executes the so-trained MLA 280 for determining the respective likelihood values of the user 220 positively engaging with each one of the plurality of digital items 235, in accordance with the non-limiting embodiments of the present technology. However, in some non-limiting embodiments of the present technology, the MLA can be trained at a third-party server; and the server 250 can be configured to execute the MLA 280.

It should be expressly understood that, in some non-limiting embodiments of the present technology, the MLA 280 can include more than one machine-learning model configured to determine the respective likelihood values of the user 220 positively engaging with the plurality of digital items 235. More specifically, along with the decision tree model 400 described above, the MLA 280 can further include additional machine-learning models. In various non-limiting embodiments of the present technology, a given additional machine-learning model can include, for example, a deep structured semantic machine-learning model. In various non-limiting embodiments of the present technology, the deep structured semantic machine-learning model can be trained, by the server 250, based on a same or different plurality of training digital objects, which is used for training the machine-learning model 400.

For example, according to certain non-limiting embodiments of the present technology, during the in-use process, a given machine-learning model of the MLA 280 can be applied to a set of digital items selected and further ranked based on the respective likelihood values determined by a preceding machine-learning model of the MLA 280. By doing so, by applying the plurality of machine-leaning models of the MLA 280, the server 250 can be configured to determine the set of recommended digital items 225 for the user 220.

According to certain non-limiting embodiments of the present technology, a given training digital objects of the plurality of training digital objects, based on which the server 250 can be configured to train the MLA 280, can include, without limitation: (i) indications of training digital items with which a given training user has interacted on the online recommendation platform 260 during a given past period, such as a day, a week, a month, and the like; (ii) the item features of these training digital items; and (iii) the user features of the given training user.

Thus, to identify the set of recommended digital items 225 for the user 220 using the so trained MLA 280, the server 250 can be configured to feed to the MLA 280: (i) indications of digital items of the plurality of digital items 235 with which the user 220 has interacted during the given past period; (ii) the item features of these digital items; and (iii) the user features of the user 220; In response, as mentioned above, the MLA 280 can be configured to determine the respective likelihood values of the user 220 positively engaging with each one of the plurality of digital items 235, as an example.

Thus, according to certain non-limiting embodiments of the present technology, in response to receiving the recommendation request 215, the server 250 can be configured to (i) to identify the set of recommended digital items 225 as described above; (ii) transmit indications of the set of recommended digital items 225 to the electronic device 210; and (iii) cause presentation of the set of recommended digital items 225 on the electronic device 210.

Further, the user 220, while appreciating the set of recommended digital items 225, is enabled to interact with each one thereof, indicating either positive or negative user engagement with them. In response to receiving an indication of a current user interaction with a given recommended digital item of the set of recommended digital items 225, in certain non-limiting embodiments of the present technology, the server 250 can be configured to adjust the user recommendations according to the current user interactions with the given recommended digital item of the set of recommended digital items 225.

More specifically, in response to receiving the current user interaction indicative of the positive user engagement of the user 220 with the given recommended digital item, as described above, the server 250 can be configured to identify an other set of recommended digital items, each recommended digital item of which is similar to the given recommended digital item, that is, has similar item features therewith. Alternatively, in response to receiving the current user interaction indicative of the negative user engagement of the user 220 with the given recommended digital item, as described above, the server 250 can be configured to identify the other set of recommended digital items, each recommended digital item of which is different from the given recommended digital item of the set of recommended digital items 225, that is, have different item features.

However, such an approach to re-determining the user recommendations based on the current user interactions of the user 220 may cause long latency times of the server 250 determining and transmitting the other set of recommended digital items to the user 220. Such latency of the server 250 can be perceived by the user 220 as a delay between a moment of executing their current user interaction with the given recommended digital item and a moment when the server transmits the other set of recommended digital items to the electronic device 210. Accordingly, this delay may affect user experience of the user 220 interacting with the online recommendation platform 260.

Thus, the developers of the present technology have devised methods and system allowing reducing the latency time of the server 250 and thus reducing the user-perceivable delay before transmitting the other set of recommended digital items. More specifically, the present methods and systems are directed to generate the set of recommended digital items 225 having a subset of core recommended digital items and auxiliary recommended digital items organized such that: a given core recommended digital item is associated with at least one auxiliary recommended digital item to be presented to the user in response to the current user interaction of the user 220 with the given core recommended digital item. More specifically, if the current user interaction is indicative of the positive user engagement of the user 220 with the given core recommended item, as described above, the at least one auxiliary recommended digital item is similar to the given core recommended item. By contrast, if the current user interaction is indicative of the negative user engagement of the user 220 with the given core recommended item, the at least one auxiliary recommended digital item is different from the given core recommended item.

Further, while the user 220 would be appreciating the at least one auxiliary recommended digital item, the server 250 could be configured to determine and provide the other recommended digital item, as described above. Thus, by reserving auxiliary recommended digital items for each one of the subset of core recommended digital items, the present methods and systems allow reducing the latency time of the server 250, thereby increasing effectiveness of the online recommendation platform 260, which may further translate to improved user experience of the user 220 from interacting with the online recommendation platform 260.

### Generating Digital Recommendations

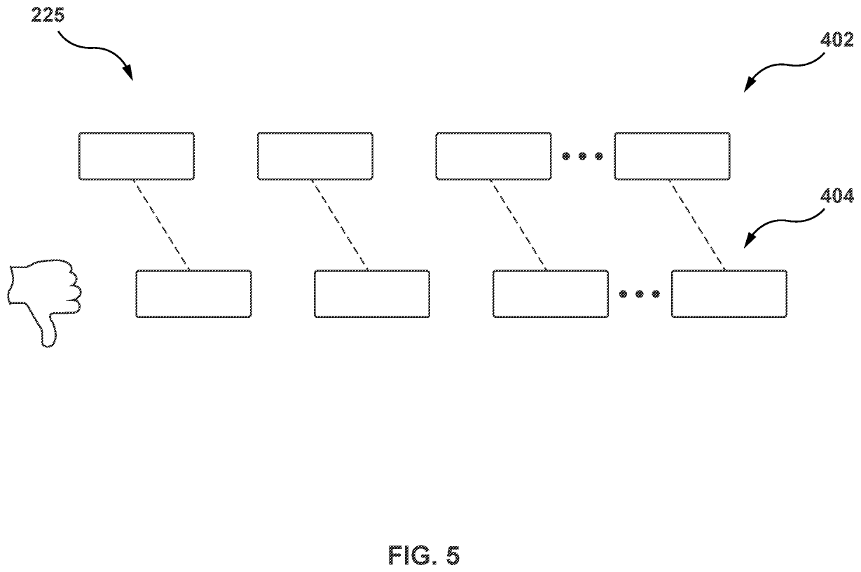

With reference to FIG. 5, there is depicted a schematic diagram of a first configuration of the set of recommended digital items 225 generated by the server 250 in response to the user 220 submitting the recommendation request 215, in accordance with certain non-limiting embodiments of the present technology.

As it can be appreciated, according to certain non-limiting embodiments of the present technology, the server 250 can be configured to determine the set of recommended digital items 225 including: (i) a subset of core recommended digital items 502 having been generated based on past user interactions of the users of the online recommendation platform 260 with the plurality of digital items 235; and (ii) a subset of auxiliary recommended digital items 504. According to certain non-limiting embodiments of the present technology, the server 250 can be configured to determine a given auxiliary recommended digital item of the subset of auxiliary recommended digital items 504 for a respective user interaction of the user 220 with a respective one of the subset of core recommended digital items 502.

More specifically, as depicted in FIG. 5, the server 250 can be configured to determine the given auxiliary recommended digital item to be provided to the user 220 in response to the respective user interaction of the user 220 indicative of the negative user engagement with the respective core recommended digital item, such as leaving negative feedback thereon or skipping it, for example, as described above. In this regard, the server 250 can be configured to determine the given auxiliary recommended digital item as being different from the respective core recommended digital item, that is, having at least one different item feature therefrom, as described above.

In another example (not depicted in FIG. 5), the server 250 can be configured to determine the given auxiliary recommended digital item of the subset of auxiliary recommended digital items 504 to be provided in response to the respective user interaction of the user 220 indicative of the positive user engagement with the respective core recommended digital item, such as leaving positive feedback thereon or sharing it on the social networks, for example, as described above. In this regard, the server 250 can be configured to determine the given auxiliary recommended digital item as being similar to the respective core recommended digital item, that is, having at least one similar item feature therewith, as described above.

It is not limited how the server 250 is configured to identify the given auxiliary recommended digital item which is one of similar to or different from the respective core recommended digital item of the subset of core recommended digital items 502. In some non-limiting embodiments of the present technology, the server 250 can be configured to determine the given auxiliary recommended digital item based on (i) past user interactions of the user 220 with the plurality of digital items 235; and (ii) an assumed indication of the respective user interaction with the respective core recommended digital item, which can be, depending on particular embodiments of the present technology, either the positive or negative user engagement of the user 220 with the respective core recommended digital item, as described above. To that end, in some non-limiting embodiments of the present technology, the server 250 can be configured to apply the MLA 280 trained as described above.

However, in other non-limiting embodiments of the present technology, the server 250 can be configured to determine the given auxiliary recommended digital item having at least one similar or different item feature with the respective core recommended digital item without applying the MLA 280. For example, the server 250 can be configured to heuristically determine the given auxiliary recommended digital item of the subset of auxiliary recommended digital items 504 as being one of (i) a most popular digital item of the plurality of digital items 235 having at least one similar or different item feature with the respective core recommended digital item of the subset of core recommended digital items 502; (ii) a digital item of the plurality of digital items having most similar or different item features with respective core recommended digital item; and the like.

Further, in some non-limiting embodiments of the present technology, the server 250 can be configured to determine more than one auxiliary recommended digital items for different respective user interactions of the user 220 with the respective core recommended digital item of the subset of core recommended digital items 502.

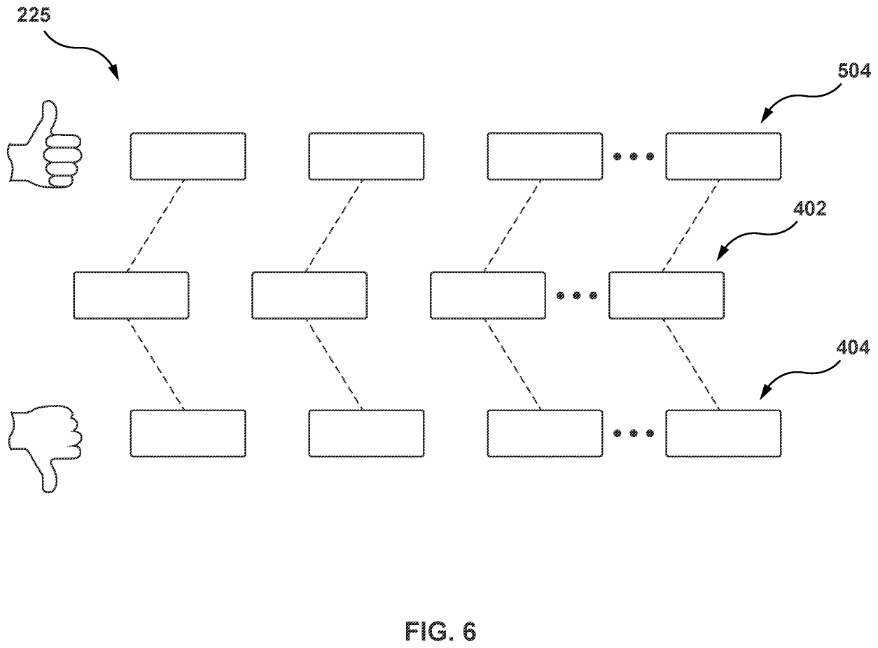

With reference to FIG. 6, there is depicted a schematic diagram of a second configuration of the set of recommended digital items 225, in accordance with certain non-limiting embodiments of the present technology.

As best shown in FIG. 6, according to certain non-limiting embodiments of the present technology, the server 250 can be configured to determine the set of recommended digital items 225 having, along with the subset of core recommended digital items 502 and the subset of auxiliary recommended digital items 504, a second subset of auxiliary recommended digital items 604. According to certain non-limiting embodiments of the present technology, the server 250 can be configured to determine a given auxiliary recommended digital item of the second subset of recommended digital items 604 to be provided in response to an other respective user interaction of the user 220 with the same respective core recommended digital item. For example, if the server 250 has determined the given one of the subset of auxiliary recommended digital items 504 for a first user interaction indicative of the negative user engagement of the user 220 with the respective core recommended digital item, the server 250 can further be configured to determine the given one of the second subset of auxiliary recommended digital items 604 for a second user interaction indicative of the positive user engagement of the user 220 with the respective core recommended digital item.

In other words, according to certain non-limiting embodiments of the present technology, the server 250 can be configured to determine, for the given core recommended digital item of the subset of core recommended digital items 502, (i) a respective first auxiliary recommended digital item from the subset of auxiliary recommended digital items 504 in case the user 220 has executed the first user interactions, indicative of the negative user engagement, with the given core recommended digital item, the respective first auxiliary recommended digital item being different from the given core recommended digital item, as described above; and (ii) a respective second auxiliary recommended digital item from the second subset of auxiliary recommended digital items 604 in case the user 220 has executed the second user interaction, indicative of the positive user engagement, with the given core recommended digital item, the respective second auxiliary recommended digital item being similar to the given core recommended digital item, as described above.

Similarly, in other non-limiting embodiments of the present technology, the server 250 can be configured to determine other respective auxiliary recommended digital items for other different user interactions indicative of both positive and negative user engagement of the user 220 with the given core recommended digital item, thereby forming more subsets of auxiliary recommended digital items for the subset of core recommended digital items 502 in the set of recommended digital items 225. More specifically, the server 250 can be configured to determine, for the given core recommended digital item: (i) a first respective auxiliary recommended digital item to be provided to the user 220 in response to the user 220 skipping the given core recommended digital item; (ii) a second respective auxiliary recommended digital item to be provided to the user 220 in response to the user 220 leaving negative feedback on the given core recommended digital item; (iii) a third respective auxiliary recommended digital item to be provided to the user 220 in response to the user 220 leaving positive feedback on the given core recommended digital item; (iv) a fourth respective auxiliary recommended digital item to be provided to the user 220 in response to the user 220 adding the given core recommended digital item to favorites; and the like.

Further, in some non-limiting embodiments of the present technology, after determining the set of recommended digital items 225 as described above, the server 250 can be configured to transmit it to the electronic device 210 for presentation to the user 220. Alongside this, the server 250 can be configured to transmit presentation instructions for the electronic device 210 to present the recommended digital items from the set of recommended digital items 225 to the user 220. In these embodiments, the presentation instructions transmitted from the server 250 can be configured to cause the electronic device 210 to execute local presentation of the set of recommended digital items 225 to the user 220. More specifically, the electronic device 210 can be configured to (i) sequentially present each one of the subset of core recommended digital items 502 of the set of recommended digital items 225, and in response to receiving an indication of the respective user interaction with the given core recommended digital item: (ii) abort the presentation of the given core recommended digital item; (iii) execute presentation of the at least one auxiliary recommended digital item, having been predetermined for the respective user interaction of the user 220 with the given core recommended digital item. As mentioned above with reference to FIGS. 4 and 5, depending on whether the respective user interaction with the given core recommended digital item was indicative of the positive or negative user engagement with the given core recommended digital item, the at least one recommended digital item can be similar to or different from the given core recommended digital item, respectively.

Further, in some non-limiting embodiments of the present technology, while the user 220 is appreciating the at least one auxiliary recommended digital item, the electronic device 210 can be configured to transmit to the server 250 a request for determining an other (new) set of recommended digital items, which can be similar in structure to the set of recommended digital items 225. According to certain non-limiting embodiments of the present technology, in response to such a request, the server 250 can be configured to determine the other set of recommended digital items including digital items that are similar to the at least one auxiliary digital item of the set of recommended digital items 225. In other words, if the at least one auxiliary digital item was similar to the given core recommended digital item, the server 250 may further be configured to generate the other set of recommended digital items including digital items that are similar to the given core recommended digital item, with which that user 220 had had positively engaged while appreciating the set of recommended digital items 225. By contrast, if the at least one auxiliary digital item was different from the given core recommended digital item, the server 250 may further be configured to generate the other set of recommended digital items including digital items that are different from the given core recommended digital item, with which that user 220 had had negatively engaged while appreciating the set of recommended digital items 225.

Further, as it can be appreciated, in response to an absence of any user interaction of the user 220 with the given core recommended digital item, the presentation instructions transmitted by the server 250 can be configured to cause the electronic device 210 to execute a presentation of a sequentially following core recommended digital items in the subset of core recommended digital items 502.

Further, in response to an absence of any user interaction of the user 220 with any one of the subset of core recommended digital items 502 in the set of recommended digital items 225 by a predetermined moment during the presentation thereof, the server 250 can be configured to determine the other set of recommended digital items having recommended digital items similar to at least one core recommended digital item of the subset of core recommended digital items 502. It is not limited how the predetermined moment for determining the other set of recommended digital items can be determined in these embodiments. In some non-limiting embodiments of the present technology, the predetermined moment can correspond to a beginning or an end of presentation of a predetermined core recommended digital item in the subset of core recommended digital items 502. In these embodiments, the predetermined moment can be selected to correspond a beginning of the presentation of the last core recommended digital item or an end of the second-to-last core recommended digital item in the subset of core recommended digital item. In other non-limiting embodiments of the present technology, the predetermined moment can correspond to a predetermined percentage of presentation of the last core recommended digital item in the subset of recommended digital items 502, such as 50%, 60%, 75%, and the like.

Also, it should be expressly understood that embodiments where the server 250 transmits to the electronic device 210 only the instructions for remote presentation of the set of recommended digital items 225, as described above, on the server 250, are also envisioned without departing from the scope of the present technology.

By doing so, the server 250 can be configured to adjust the digital user recommendations to the current user interactions and also reduce the latency time of the server 250 caused by real-time determination of the other set of recommended digital items. Accordingly, user-perceivable delays of the user 220 between the respective user interaction with the given core recommended digital item and presenting the other set of recommended set of digital items can be reduced.

Also, in some non-limiting embodiments of the present technology, the server 250 can be configured to determine the set of recommended digital items 225 having a predetermined number of digital items in the subset of core recommended digital items 502. In some non-limiting embodiments of the present technology, this predetermined number can be relatively small, such as 5, 10, or 20 digital items, for example. In other non-limiting embodiments of the present technology, the predetermined number of digital items for the subset of core recommended digital items 502 in the set of recommended digital items 225 can be determined based on a trade-off between a desired degree of the latency of the server 250 and available computational resources thereof. In other words, the predetermined number of digital items can be determined such that the latency time of the server 250, caused by determination of the other set of recommended digital items, would not cause or minimize the user-perceivable delay before receiving the other set of recommended digital items.

### Method

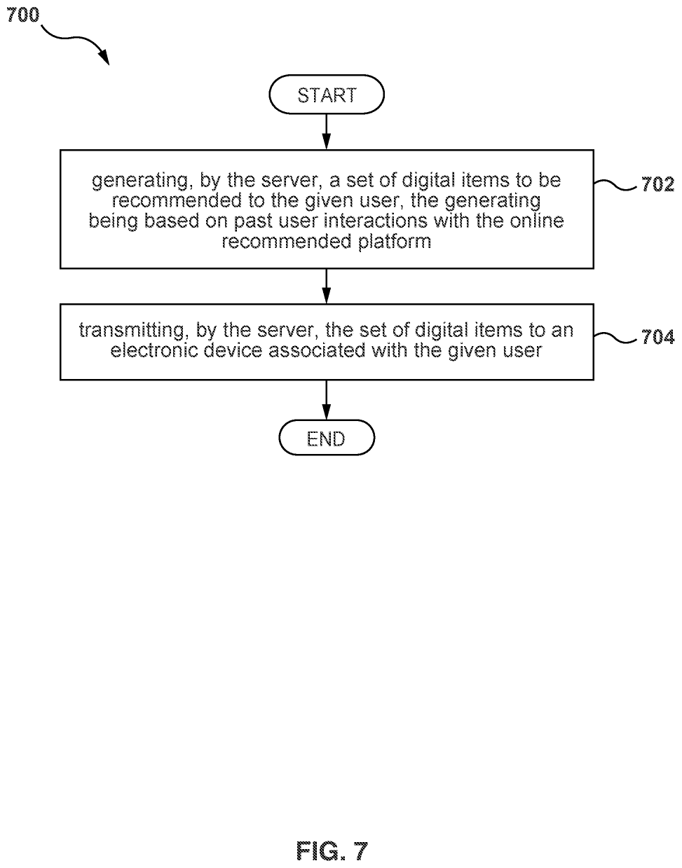

Given the architecture and the examples provided hereinabove, it is possible to execute a method for generating digital item recommendations for users of the online recommendation platform 260, such as the user 220 mentioned above. With reference now to FIG. 7, there is depicted a flowchart of a method 700, according to certain non-limiting embodiments of the present technology. The method 700 may be executed by server 250.

Step 702: Generating, by the Server, a Set of Digital Items to be Recommended to the Given User, the Generating being Based on Past User Interactions with the Online Recommendation Platform

The method 700 commences at step 702 with the server 250 being configured to (i) receive a recommendation request, such as the recommendation request 215, from the electronic device 210 of the user 220; and (ii) in response to the recommendation request 215, generate the set of recommended digital items 225.

As mentioned above, according to various non-limiting embodiments of the present technology, the recommendation request 215 can be triggered at least by one of: (i) the user 220 expressly submitting the recommendation request 215 via the GUI 300 of the online recommendation platform 260; (ii) the user 220 accessing the online recommendation platform 260; and (iii) the user 220 appreciating the given digital item of the plurality of digital items 235 hosted by the online recommendation platform 260.

Further, according to certain non-limiting embodiments of the present technology, the server 250 can be configured to generate the set of recommended digital items 225 based on the past user interactions of the users of the online recommendation platform 260 with the plurality of digital items 235. More specifically, in some non-limiting embodiments of the present technology, the server 250 can be configured to generate the set of recommended digital items 225 such that a likelihood value of the positive user engagement of the user 220 with each one of the set of recommended digital items 225 is maximized. In other non-limiting embodiments of the present technology, the server 250 can be configured to identify the set of recommended digital items 225 such that a likelihood value of the negative user engagement of the user 220 with each one of the set of recommended digital items 225 is minimized. To that end, in some non-limiting embodiments of the present technology, the server 250 can be configured to apply the MLA 280 trained as described above.

Further, as mentioned further above with reference to FIGS. 4 and 5, in some non-limiting embodiments of the present technology, the server 250 can be configured to generate the set of recommended digital items 225 including the subset of core recommended digital items 502, a given core recommended digital item of which is associated with the at least one auxiliary digital item. According to certain non-limiting embodiments of the present technology, the server 250 can be configured to determine the at least one auxiliary recommended digital item can be determined, such as by using the MLA 280, based on (i) the past user interactions of the users of the online recommendation platform 260, such as the user 220, with the plurality of digital items 235; and (ii) an assumption that the user 220 has executed the respective user interaction with the given core recommended digital item.

More specifically, as described above with reference to FIGS. 4 and 5, in response to the respective user interaction of the user 220 indicative of the negative user engagement with the given core recommended digital item, such as leaving negative feedback thereon or skipping it, for example, the server 250 can be configured to determine the at least one auxiliary recommended digital item which is different from the given core recommended digital item, that is, having different item features from those of the given core recommended digital items of the subset of core recommended digital item 502.

By contrast, in response to the respective user interaction of the user 220 indicative of the positive user engagement with the respective core recommended digital item, such as leaving positive feedback thereon or sharing it on the social networks, for example, as described above, the server 250 can be configured to determine the at least one auxiliary recommended digital item of the subset of auxiliary recommended digital items, which is similar to the given core recommended digital item, that is, having at least one similar item feature therewith, as described above.

As mentioned further above, according to certain non-limiting embodiments of the present technology, the item features associated with the given digital item may be indicative of inherent parameters thereof; and, as it can be appreciated, can depend on a nature of the given current digital item. For example, in those embodiments where the online recommendation platform 260 is an audio streaming platform, and the given digital item is a respective audio track, the item features can include, without limitation, (i) a genre of the respective audio track; (ii) a predetermined mood to be induced by the respective audio track; (iii) a period of popularity associated with the respective audio track, such as the sixties, the seventies, the nineties, and the like; (iv) a respective item provider of the respective audio track, such as an artist, a producer, a production studio, and the like; (v) a duration of the respective audio track; (vi) a release date of the respective audio track; (vii) a rhythm of the respective audio track; (viii) an album of the respective audio track; and the like.

By doing so, the server 250 can be configured to generate, in the set of recommended digital items 225, for each respective user interaction of the user 220 with the subset of core recommended digital items 502, a respective subset of auxiliary recommended digital items, such as the subset of auxiliary recommended digital items 504 described above, each auxiliary recommended digital item of which is associated with a respective core recommended digital item of the subset of core recommended digital item 502.

The method 700 thus advances to step 704.

Step 704: Transmitting, by the Server, the Set of Digital Items to an Electronic Device Associated with the Given User

Further, at step 704, once the server 250 has generated the set of recommended digital items 225 in response to the recommendation request 215 of the user 220, the server 250 can further be configured to transmit the set of recommended digital items 225 to the electronic device 210 associated with the user 220.

As mentioned above along with the set of recommended digital items 225, the server 250 can be configured to transmit the presentation instructions for the electronic device 210 to present the recommended digital items from the set of recommended digital items 225 to the user 220. In these embodiments, the presentation instructions transmitted from the server 250 can be configured to cause the electronic device 210 to execute local presentation of the set of recommended digital items 225 to the user 220. More specifically, the electronic device 210 can be configured to (i) sequentially present each one of the subset of core recommended digital items 502 of the set of recommended digital items 225, and in response to receiving an indication of the respective user interaction with the given core recommended digital item: (ii) abort the presentation of the given core recommended digital item; (iii) execute the presentation of the at least one auxiliary recommended digital item, having been predetermined for the respective user interaction of the user 220 with the given core recommended digital item.

Further, in some non-limiting embodiments of the present technology, while the user 220 is appreciating the at least one auxiliary recommended digital item, the electronic device 210 can be configured to transmit to the server 250 an other recommendation request for determining the other (new) set of recommended digital items, which can be similar in structure to the set of recommended digital items 225. According to certain non-limiting embodiments of the present technology, in response to the other recommendation request, the server 250 can be configured to determine the other set of recommended digital items including digital items that are similar to the at least one auxiliary digital item of the set of recommended digital items 225.

Further, as it can be appreciated, in an absence of any user interaction of the user 220 with the given core recommended digital item, the presentation instructions transmitted by the server 250 can be configured to cause the electronic device 210 to execute the presentation of the sequentially following core recommended digital items in the subset of core recommended digital items 502.

Further, in response to an absence of any user interaction of the user 220 with any one of the subset of core recommended digital items 502 in the set of recommended digital items 225 by the predetermined moment during the presentation thereof, as described above, the server 250 can be configured to determine the other set of recommended digital items having recommended digital items similar to at least one core recommended digital item of the subset of core recommended digital items 502. As mentioned above, in some non-limiting embodiments of the present technology, the predetermined moment can correspond, for example, to a predetermined percentage of presentation of the last core recommended digital item in the subset of recommended digital items 502, such as 50%, 60%, 75%, and the like.

Also, it should be expressly understood that embodiments where the server 250 transmits to the electronic device 210 only the instructions for remote presentation of the set of recommended digital items 225, as described above, on the server 250, are also envisioned without departing from the scope of the present technology.

Also, in some non-limiting embodiments of the present technology, the server 250 can be configured to determine the set of recommended digital items 225 having a predetermined number of digital items in the subset of core recommended digital items 502. In some non-limiting embodiments of the present technology, this predetermined number can be relatively small, such as 5, 10, or 20 digital items, for example. In other non-limiting embodiments of the present technology, the predetermined number of digital items for the subset of core recommended digital items 502 in the set of recommended digital items 225 can be determined based on a trade-off between a desired degree of the latency of the server 250 and available computational resources thereof.

The method 700 thus terminates.

Thus, certain embodiments of the method 700 allow adjusting the digital user recommendations to the current user interactions and also reduce the latency time of the server 250 caused by real-time determination of the other set of recommended digital items.

Accordingly, user-perceivable delays of the user 220 between the respective user interaction with the given core recommended digital item and presenting the other set of recommended set of digital items can be reduced, thereby improving the user experience of the user 220 from interacting with the online recommendation platform 260.

Modifications and improvements to the above-described implementations of the present technology may become apparent to those skilled in the art. The foregoing description is intended to be exemplary rather than limiting. The scope of the present technology is therefore intended to be limited solely by the scope of the appended claims.

While the above-described implementations have been described and shown with reference to particular steps performed in a particular order, it will be understood that these steps may be combined, sub-divided, or re-ordered without departing from the teachings of the present technology. Accordingly, the order and grouping of the steps is not a limitation of the present technology.

1. A computer-implementable method of generating digital item recommendations for a given user of an online recommendation platform, the online recommendation platform hosting a plurality of digital items, the method being executable by a server hosting the online recommendation platform, the method comprising:
generating, by the server, a set of digital items to be recommended to the given user, the generating being based on past user interactions with the online recommendation platform,
the set of digital items including:
a sub-set of core digital items selected for the user based on the past user interactions, for a given core digital item of the sub-set of core digital items, the set of digital items further including:
at least one auxiliary digital item to be provided to the given user in response to a respective user interaction of the given user with the given core digital item during appreciation thereof,
the at least one auxiliary digital item having been determined based on (i) past user interactions of the given user with the plurality of digital items and (ii) an assumption that the given user has executed the respective user interaction with the given core digital item; and
transmitting, by the server, the set of digital items to an electronic device associated with the given user.

2. The method of claim 1, further comprising determining, by the server, the at least one auxiliary digital item.

3. The method of claim 2, wherein the determining the at least one auxiliary digital item comprises:
in case of the respective user interaction is indicative of a positive user engagement with the given core digital item, determining, by the server, the at least one auxiliary digital item which is similar to the given core digital item; and
in case of the respective user interaction is indicative of a negative user engagement with the given core digital item, determining, by the server, the at least one auxiliary digital item which is different from the given core digital item.

4. The method of claim 3, wherein:
each one of the plurality of digital items is associated with at least one item feature; and
the determining the at least one auxiliary digital item which is one of similar to and different from the given core digital item comprises determining, by the server, in the plurality of digital items, a digital item having the at least one feature which is, respectively, one of similar to and different from a respective item feature of the given core digital item.

5. The method of claim 4, wherein the at least one item feature comprises one of: a category of the digital item and an item provider of the digital item.

6. The method of claim 4, wherein:
the online recommendation platform is an audio streaming platform;
the digital item is an audio track; and
the at least one item feature comprises one of: a genre of the audio track, a mood induced by the audio track, a rhythm of the audio track, an artist performing the audio track, an album including the audio track, and user-generated playlists including the audio track.

7. The method of claim 3, wherein the at least one auxiliary digital item comprises:
a first auxiliary digital item, similar to the given core digital item, to be provided to the given user in case of the respective user interaction being indicative of the positive user engagement with the given core digital item; and
a second auxiliary digital item, different from the given core digital item, to be provided to the given user in case of the respective user interaction being indicative of the negative user engagement with the given core digital item.

8. The method of claim 2, wherein the determining the at least one auxiliary digital item further comprises applying a machine-learning algorithm (MLA) having been trained to determine, in the plurality of digital items, recommended digital items for users of the online recommendation platform based on past user interactions of the users with the plurality of digital items.

9. The method of claim 1, further comprising:
causing, by the server, presentation of the set of digital items on the electronic device associated with the given user; such that
in response to receiving an indication of the respective user interaction with the given core digital item during the appreciation thereof, the electronic device is configured to:
abort presentation of the given core digital item;
execute presentation of the at least one auxiliary digital item; and
transmit a request to the server for generating, by the server, based on the at least on the auxiliary digital item, an other set of digital items to be recommended to the given user after appreciation of the auxiliary digital item such that:
each one of a respective sub-set of core digital items of the other set of digital items is similar to the at least one auxiliary digital item; and
in response to an absence of any user interaction with the given core digital item, the electronic device is configured to: execute, after the presentation of the given core digital item, presentation of a sequentially following core digital item in the sub-set of core digital items.

10. The method of claim 9, wherein the presentation of the set of digital items on the electronic device associated with the given user is further configured to trigger the electronic device to: in response to an absence of any user interaction with any one of the sub-set of core digital items until a predetermined percentage of presentation of a last one thereof, transmit a request to the server for generating, by the server, the other set of digital items to be recommended to the given user after appreciation of the set of digital items such that:
each one of the respective sub-set of core digital items of the other set of digital items is similar to at least one of the sub-set of core digital items of the set of digital items.

11. The method of claim 1, wherein the respective user interaction comprises the given user providing user feedback about the at least one auxiliary digital item.

12. The method of claim 1, wherein the sub-set of core digital items has a predetermined number of digital items.

13. The method of claim 12, wherein the predetermined number of digital items has been determined such that a latency of the server is minimized.

14. The method of claim 1, wherein the online recommendation platform is an audio streaming platform; and a given one of the plurality of digital items is a respective audio track.

15. A server for generating digital item recommendations for a given user of an online recommendation platform hosted by the server, the online recommendation platform hosting a plurality of digital items, the server comprising a processor and a non-transitory computer-readable memory storing instructions, and the processor, upon executing the instructions, being configured to:
generate a set of digital items to be recommended to the given user, the generating being based on past user interactions with the online recommendation platform,
the set of digital items including:
a sub-set of core digital items selected for the user based on the past user interactions, for a given core digital item of the sub-set of core digital items, the set of digital items further including:
at least one auxiliary digital item to be provided to the given user in response to a respective user interaction of the given user with the given core digital item during appreciation thereof,
the at least one auxiliary digital item having been determined based on (i) past user interactions of the given user with the plurality of digital items and (ii) an assumption that the given user has executed the respective user interaction with the given core digital item; and
transmit the set of digital items to an electronic device associated with the given user.

16. The server of claim 15, wherein the processor is further configured to determine the at least one auxiliary digital item.

17. The server of claim 16, wherein the processor is configured to determine the at least one auxiliary digital item, by:
in case of the respective user interaction is indicative of a positive user engagement with the given core digital item, determining the at least one auxiliary digital item which is similar to the given core digital item; and
in case of the respective user interaction is indicative of a negative user engagement with the given core digital item, determining the at least one auxiliary digital item which is different from the given core digital item.

18. The server of claim 17, wherein:
each one of the plurality of digital items is associated with at least one item feature; and
the processor is configured to determine the at least one auxiliary digital item which is one of similar to and different from the given core digital item by determining, in the plurality of digital items, a digital item having the at least one feature which is, respectively, one of similar to and different from a respective item feature of the given core digital item.

19. The server of claim 16, wherein to determine the at least one auxiliary digital item the processor is further configured to apply a machine-learning algorithm (MLA) having been trained to determine, in the plurality of digital items, recommended digital items for users of the online recommendation platform based on past user interactions of the users with the plurality of digital items.

20. The server of claim 15, wherein the processor is further configured to:
cause presentation of the set of digital items on the electronic device associated with the given user; such that
in response to receiving an indication of the respective user interaction with the given core digital item during the appreciation thereof, the electronic device is configured to:
abort presentation of the given core digital item;
execute presentation of the at least one auxiliary digital item; and
transmit a request to the server for generating, by the server, based on the at least on the auxiliary digital item, an other set of digital items to be recommended to the given user after appreciation of the auxiliary digital item such that:
each one of a respective sub-set of core digital items of the other set of digital items is similar to the at least one auxiliary digital item; and
in response to an absence of any user interaction with the given core digital item, the electronic device is configured to: execute, after the presentation of the given core digital item, presentation of a sequentially following core digital item in the sub-set of core digital items.
